(19) United States
(12) Patent Application Publication
(10) Pub. No.: US 2011/0290728 A1
(43) Pub. Date: Dec. 1, 2011

(54) SWRO Pressure Vessel and Process That Increases Production and Product Quality and Avoids Scaling Problems

(75) Inventor: Orlando J. Viera Curbelo, Las Palmas de Gran Canaria (ES)

(73) Assignee: GENERAL ELECTRIC COMPANY, Schenectady, NY (US)

(21) Appl. No.: 12/786,784

(22) Filed: May 25, 2010

(51) Int. Cl. C02F 1/44; B01D 65/08

(52) U.S. Cl. 210/652; 210/321.72

(57) ABSTRACT

An SWRO module for use in a desalination plant receives refresh water to increase production and product quality and reduce scaling problems. The SWRO module includes a pressure vessel having a front-end feed port, a rear-end brine port and a rear-end permeate port. A plurality of RO membrane elements are located in series within the pressure vessel. At least one refresh port leading to an interconnector mixing zone within the pressure vessel is located between two of the plurality of RO membrane elements. The port is configured such that refresh water added to the SWRO module through the refresh port mixes with the feed water supplied through the front-end feed port in the interconnector mixing zone.

### BACKGROUND OF THE INVENTION

1. Field of the Invention

This invention relates generally to desalination of seawater water for production of fresh water using a reverse osmosis process, and more particularly, to a desalination process that includes refreshing the brine water in a reverse osmosis module.

2. Description of Related Art

Sea water reverse osmosis (SWRO) is an effective and energy-saving method of desalination which is widely employed for obtaining potable water. The method consists in applying mechanical pressure over a saline solution, such as seawater, which is higher than the osmotic pressure of the same solution, in a volume delimited by a semi-permeable membrane (RO membrane). The solvent (sea water) is squeezed through the membrane to its “permeate” side while dissolved salts remain in the solution at the “feed” side of the membrane.

Desalination processes typically have high energy requirements per unit of desalinated water product and operate at relatively low yields. They have therefore been economical only for those locations where fresh water shortages are acute and energy costs are low. Often, desalination processes cannot compete effectively with other sources of fresh water, such as overland pipelines or aqueducts from distant rivers and reservoirs. However, because there is a vast volume of water present in the oceans and seas, and because direct sources of fresh water (such as inland rivers, lakes and underground aquifers) are becoming depleted, contaminated, or reaching capacity limits, there is a desire for an economical process for desalination of sea water.

Desalination of sea water must take into account important properties of the sea water: turbidity, hardness and salinity (ionic content and total dissolved solids [TDS]) and the presence of suspended particulates and microorganisms. These properties typically place limits of about 30%-35% on the amount of fresh water yield that can be expected from prior art desalination process as used or proposed. Reference is made in this application to “sea water”, which includes water from seas and oceans but can also include water from various salt lakes and ponds, brackish water sources, brines, and other surface and subterranean sources of water having ionic contents which classify them as “saline.” This can generally be considered to be water with a salt content of greater than 1000 parts per million (ppm). Since sea water has the greatest potential as a source of potable water (i.e., generally considered to be water with a salt content of less than 500 ppm), this application will focus on sea water desalination. However, it will be understood that all sources of saline water are to be considered to be within the present invention, and that focus on sea water is for brevity and not to be considered to be limiting.

SWRO plants are severely limited by factors such as turbidity (TDS) of the water feed. The feed osmotic pressure increases with the TDS. From the principles of RO, the applied pressure is necessarily used to overcome the osmotic pressure, and the remaining pressure is the net water driving pressure through the membrane. The lower the osmotic pressure can be made, the greater the net water driving pressure, and therefore the greater the amount of pressure available to drive the permeate water through the membrane, which also produces a higher quantity of product.

It would therefore be desirable to have a process which would economically produce a good yield of fresh water from sea water, and which would effectively deal with the problems mentioned above; i.e., removal of hardness and turbidity from such saline water and the lowering of total dissolved solids.

### SUMMARY OF THE INVENTION

In one aspect, the invention is directed to a desalination method using a reverse osmosis process for production of fresh water. The method includes supplying feed water to a sea water reverse osmosis (SWRO) module having a pressure vessel and a plurality of RO membrane elements. Refresh water is supplied to an interconnector mixing zone through a refresh port in the pressure vessel that leads to an interconnector mixing zone that is located between two of the RO membrane elements such that the refresh water mixes with the feed water. In one embodiment, the refresh water is supplied to the port through a bypass line that connects to the discharge of a high-pressure pump that also supplies the feed water to the SWRO module.

Another aspect of the invention is directed to a SWRO module for use in a desalination plant. The SWRO module includes a pressure vessel having a front-end feed port, a rear-end brine port and a rear-end permeate port. A plurality of RO membrane elements are located in series within the pressure vessel. At least one refresh port leading to an interconnector mixing zone within the pressure vessel is located between two of the plurality of RO membrane elements. The port is configured such that refresh water added to the SWRO module through the refresh port mixes with the feed water supplied through the front-end feed port in the interconnector mixing zone.

The present invention and its advantages over the prior art will become apparent upon reading the following detailed description and the appended claims with reference to the accompanying drawings.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic of a desalination plant in accordance with an embodiment of the invention;

FIG. 2 is a plan view of an SWRO module of the desalination plant of FIG. 1; and

FIG. 3 is a sectional view of the SWRO module of FIG. 2 taken along line 3-3 in FIG. 2.

Corresponding reference characters indicate corresponding parts throughout the views of the drawings.

### DETAILED DESCRIPTION OF THE INVENTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

The singular forms “a,” “an” and “the” include plural referents unless the context clearly dictates otherwise.

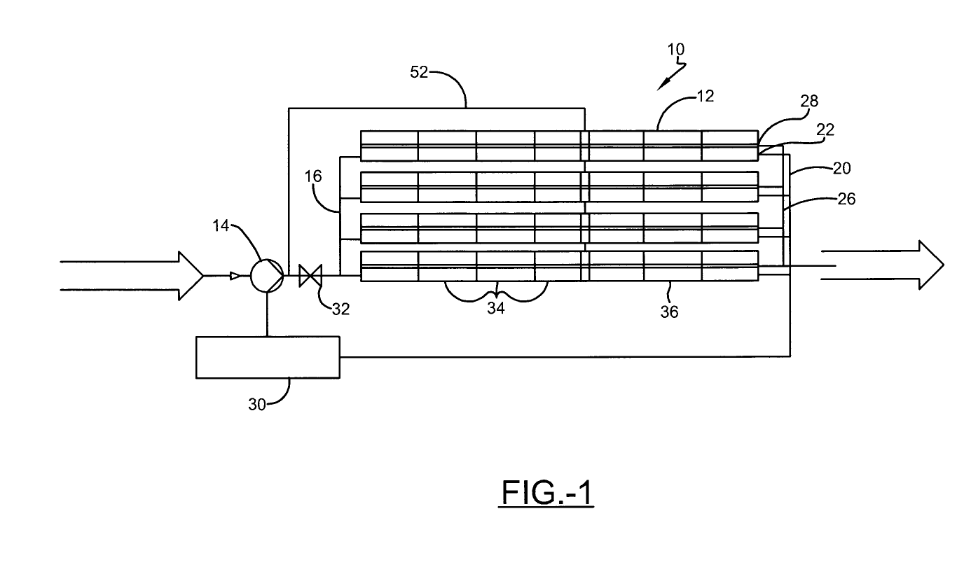

With reference to FIG. 1, there is shown a desalination plant 10 comprising a plurality of SWRO modules 12 for SWRO separation connected in parallel and interconnecting piping and control means as explained below. The desalination plant 10 is connected to a source of raw solution (seawater) such as water pretreatment stage (not shown) at the inlet of the HPP 14. One or more high-pressure pumping groups (HPP) 14, which may have variable frequency drive (VFD) as is known in the art, pressurizes the feed water. Before entering the SWRO modules, clarified sea water is pressurized by the HPP typically between about 55 and 85 bars (about 6.0 and 7.0 Mpa), depending on the temperature and the salinity of the water. The pump may be a plunger or piston pump or a centrifugal pump as is known in the art. The illustrated desalination plant 10 has a common high-pressure feed line 16 connecting HPP 14 to the front-end feed ports 18 of the SWRO modules 12 via high pressure feed lines. The desalination plant 10 also has a common high-pressure brine collector 20 connected to the rear-end brine ports 22 of the modules 12 via high-pressure brine lines and a common rear permeate collector 26 connected to rear-end permeate ports 28 via rear permeate lines. One skilled in the art will understand the front-end feed port 18 and the rear-end brine ports 22 may also be located on the side of the SWRO module 12 but near the front-end or rear-end, respectively, without departing from the scope of the invention. The brine collected in the common high-pressure brine collector 20 may be directed to a booster pump and second stage SWRO modules (not shown) or to an energy recovery device (ERD) 30. In the ERD 30, the high pressure of the brine is transferred to the feed water while the brine is discharged through an outlet. The second stage SWRO modules and ERD 30 may be any system known in the art and need not be discussed in further detail herein. The outlet of permeate collector 26 is connected to next separation stages or product tanks (not shown). Pressure control on the SWRO modules 12 may be controlled using a flow control valve 32 installed in the discharge pipe of the HPP 14.

Each SWRO module 12 includes one or more RO membrane elements 34 enclosed in a pressure vessel 36. The number of RO membrane elements 34 per pressure vessel 36 can vary from, for example, 1 to 9. In the illustrated embodiment, each pressure vessel 36 contains 7 RO membrane elements 34. Typical diameters of RO membrane elements 34 are 2.5 inches (6.4 cm), 4 inches (10.2 cm) and 8 inches (20.3 cm). RO membrane elements 34 typically have a maximum permeate flow rate ranging from 1.4 to 37.9 m³/d; therefore, many membrane elements are often required to meet the permeate production requirements of the desalination plant 10. One common RO membrane used in desalination is a spiral wound thin film composite consisting of a flat sheet sealed like an envelope and wound in a spiral. However, one skilled in the art will understand that any known RO membrane element 12 may be used in the pressure vessel without departing from the scope of the invention. One suitable example is model SU-820 available from Toray Industries, Inc. As is known, SWRO modules 12 are arranged in parallel to satisfy the membrane flow and pressure specifications as well as the plant production requirements. The total number of RO membrane elements 34 and pressure vessels 36 required and their arrangement (i.e., the array configuration) depends on permeate flow requirements and parameters of the incoming feed water such as salinity and temperature.

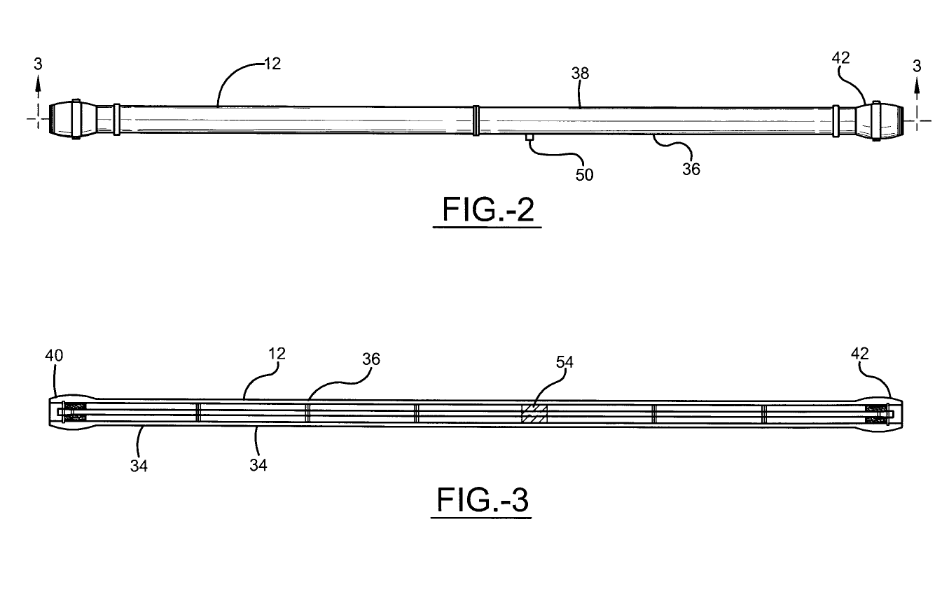

Turning now to FIGS. 2 and 3, the pressure vessel 36 has an elongated housing 38 having a front end 40 and a rear end 42. As is known in the art, the RO membrane elements 34 extend between the front end 40 and the rear end 42 dividing the internal volume of the housing 38 into a feed side and a permeate side. The membrane of each RO membrane element 34 has, consequently, feed side surface and permeate side surface. The housing 38 connects to the front-end feed port 18 and the rear-end brine port 22 in communication with the feed side of the RO membrane elements 34, and the rear-end permeate port 28 in communication with the permeate side of the membranes. The sea water usually contains potential foulants such as suspended particles, organic molecules, live microorganisms or dissolved salts which may form scale. During the process of separation, the foulants accumulate at the feed side of the RO membrane contaminating it, reducing its permeability and increasing the hydraulic losses across the SWRO module 12.

According to the invention, a refresh port 50 is added to the housing 38 intermediate the front end 40 and rear end 42. A bypass line 52 (FIG. 1) is installed in the high-pressure feed line 16 between the discharge of the HPP 14 and the control valve 32, and connects to the refresh port 50 in the pressure vessel 36. The RO membrane elements 34 are located in the pressure vessel 36 such that there is an interconnector mixing zone 54 in the feed side of the pressure vessel 36, with the refresh port 50 leading to the interconnector mixing zone 54. In the illustrated embodiment, the refresh port 50 and interconnector mixing zone 54 are located between the fourth RO membrane element 34 and the fifth RO membrane element 34 in the pressure vessel 36. However, one skilled in the art will understand that the refresh port 50 and interconnector mixing zone 54 may be located between any other RO membrane elements 34, such as, for example, between the fifth and sixth RO membrane elements. Desirably, the interconnector mixing 54 zone has a length of between about 150 mm and 250 mm, and more desirably about 200 mm to provide for mixing of the concentrated feed water and the incoming refreshing feed water. However, one skilled in the art will understand that other dimensions may also be used for the size of the interconnector mixing zone 54. Additionally, one skilled in the art will understand that multiple refresh ports may be located along the housing 38 leading to different interconnector mixing zones 54 between the RO membrane elements 34.

Sea water is added to the interconnector mixing zone 54 through the refresh port 50 to refresh the feed water that flows into the RO membrane elements 34 positioned toward the rear end of the pressure vessel 36. Desirably, refresh water is added at a rate of between about 1.5 m³/hr and about 6.0 m³/hr. However, one skilled in the art will understand that these rates are for example purposes only and may differ depending on the particular SWRO module and quality of the feed water. In the illustrated embodiment, refreshing the feed water reduces the TDS of the feed water to the three RO membrane elements 34 toward the rear end 42 of the pressure vessel 36, thereby increasing the production and improving the product quality from these last three RO membrane elements 34. It will be understood that the extra feed water requirements that result from the additional flow that is directed through the bypass line 52 can be made up by opening the control valve 32 in the discharge pipe of the HPP 14 and passing the extra flow of feed water directly to the interconnector mixing zone 54. As will be understood, having the control valve 32 in the discharge of the HPP 14 causes an energy loss due the drop in pressure across the control valve 32 that is required to keep the desired pressure for the RO membrane elements 34. By moving along the pump curve of the HPP 14, more feed water is pumped at the nominal pressure of operation.

Table 1 provides exemplary production and product quality measurements. Additionally, since the concentration of brine is reduced, energy consumption is lowered and chemical consumption during operation is reduced. Scaling problems in the final membrane elements are also reduced, thereby possibly prolonging membrane element life.

TABLE 1

| | Without Refresh | With Refresh |
|---|---|---|
| Feed flow (m³/h) | 8.68 | 10.58 |
| Production recovery (m³/h) | 3.48 | 3.80 |
| Recovery | 40.09% | 35.92% |
| Ca | 0.49 | 0.43 |
| Mg | 1.88 | 1.66 |
| Na | 64.91 | 57.28 |
| K | 2.48 | 2.20 |
| NH4 | 0.00 | 0.00 |
| Ba | 0.00 | 0.00 |
| Sr | 0.01 | 0.00 |
| CO₃ | 0.00 | 0.00 |
| HCO₃ | 1.21 | 1.07 |
| SO₄ | 4.48 | 3.96 |
| Cl | 104.48 | 92.23 |
| F | 0.01 | 0.01 |
| NO₃ | 0.25 | 0.22 |
| B | 0.54 | 0.48 |
| SiO₂ | 0.01 | 0.00 |
| TDS | 180.80 | 159.54 |
| pH | 6.2 | 6.1 |

An SWRO separation process in the desalination plant 10 will now be described. Pretreated sea water is supplied to the suction side of HPP 14. High-pressure feed water supplied from HPP 14 enters the high-pressure feed collector 16 and, via high-pressure feed lines the front-end feed ports 18 on the feed side of the SWRO modules 12. The excess pressure drives the water to the permeate side of the RO membrane elements 34. The obtained permeate product has low TDS content and low osmotic pressure. The permeate is withdrawn from the permeate side under gauge pressure. The feed water salinity and osmotic pressure increase as the feed water flows towards the rear end 42 of the SWRO module 12 while the gauge pressure falls due to hydraulic losses. Therefore, the net driving differential falls, and the permeate salinity varies along the membrane. The feed water is refreshed by adding sea water to the SWRO module 12 and mixing with the concentrated feed water in the interconnector mixing zone 54. The sea water that reaches the rear end 42 of the feed side is high-salinity brine and exits the SWRO module 12 via the rear-end brine port 28, high-pressure brine collector 20 and is passed to the ERD 30.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the scope of the disclosure as defined by the following claims.

What is claimed is:

1. A desalination method using a reverse osmosis process for production of fresh water, the method comprising:
supplying feed water to a sea water reverse osmosis module having a pressure vessel and a plurality of RO membrane elements;
supplying refresh water to an interconnector mixing zone through a refresh port in the pressure vessel, wherein the interconnector mixing zone is located between a first RO membrane element of said plurality and a second RO membrane element of the plurality of RO membrane elements such that the refresh water mixes with the feed water.

2. The desalination method of claim 1 wherein the refresh water is supplied to the refresh port through a bypass line that connects a discharge of a high pressure pump to the port, wherein said high pressure pump also supplies the feed water to the sea water reverse osmosis module.

3. The desalination method of claim 1 wherein there are seven RO membrane elements in the pressure vessel and the interconnector mixing zone is located between the fourth and the fifth RO membrane elements.

4. The desalination method of claim 1 wherein the interconnector mixing zone in the pressure vessel has a length of between about 150 mm and 250 mm between adjacent RO membrane elements.

5. A sea water reverse osmosis module for use in a desalination plant, the sea water reverse osmosis module comprising:
a pressure vessel having a front-end feed port, a rear-end brine port and a rear-end permeate port;
a plurality of RO membrane elements in series within the pressure vessel;
wherein the pressure vessel has at least one refresh port leading to an interconnector mixing zone within the pressure vessel located between a first RO membrane element and a second RO membrane element of said plurality of RO membrane elements, the port being configured such refresh water added to the sea water reverse osmosis module through the refresh port mixes with feed water supplied through the front-end feed port in the interconnector mixing zone.

6. The sea water reverse osmosis module of claim 5 wherein there are seven RO membrane elements in the pressure vessel and the interconnector mixing zone is located between the fourth and the fifth RO membrane elements.

7. The sea water reverse osmosis module of claim 5 wherein the interconnector mixing zone in the pressure vessel has a length of between about 150 mm and 250 mm between adjacent RO membrane elements.

8. The sea water reverse osmosis module of claim 5 wherein the pressure vessel has a plurality of refresh ports.
